(19) United States
(12) Patent Application Publication
(10) Pub. No.: US 2025/0265694 A1
(43) Pub. Date: Aug. 21, 2025

(54) DEEP LEARNING MODEL DIAGNOSTICS TOOLS USING STACKED IMAGES

(71) Applicant: KLA Corporation, Milpitas, CA (US)

(72) Inventors: Haixu Leng, Canton, MI (US); Jasleen Chhabra, Ypsilanti, MI (US)

(21) Appl. No.: 18/603,002

(22) Filed: Mar. 12, 2024

Related U.S. Application Data
(60) Provisional application No. 63/554,145, filed on Feb. 15, 2024.

(51) Int. Cl. G06T 7/00; G06T 7/33; G06T 7/73

(52) U.S. Cl. CPC G06T 7/0004; G06T 7/337; G06T 7/74; G06T 2207/20081; G06T 2207/20084; G06T 2207/30148

(57) ABSTRACT

Methods and systems for generating information for use in evaluating a deep learning (DL) model are provided. One method includes acquiring results generated by a DL model configured for assigning an attribute to images generated for a specimen responsive to a likelihood that the images are images of interest. The method also includes separating the images into groups based on the attribute such that each of the two or more groups corresponds to different values of the attribute and aligning the images in each of the two or more groups to each other. In addition, the method includes stacking the aligned images within each of the two or more groups thereby highlighting in the stacked images one or more features of the images to which the attribute is responsive and outputting the stacked images for use in evaluating the DL model.

### BACKGROUND OF THE INVENTION

### 1. Field of the Invention

The present invention generally relates to methods and systems for deep learning (DL) model diagnostics tools using stacked images. The embodiments described herein are particularly advantageous as diagnostics tools that use stacked images to show value of DL models in optical and other wafer inspection.

### 2. Description of the Related Art

The following description and examples are not admitted to be prior art by virtue of their inclusion in this section.

Fabricating semiconductor devices such as logic and memory devices typically includes processing a specimen such as a semiconductor wafer using a number of semiconductor fabrication processes to form various features and multiple levels of the semiconductor devices. For example, lithography is a semiconductor fabrication process that typically involves transferring a pattern to a resist arranged on a semiconductor wafer. Additional examples of semiconductor fabrication processes include, but are not limited to, chemical-mechanical polishing, etch, deposition, and ion implantation. Multiple semiconductor devices may be fabricated in an arrangement on a semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Many yield related processes such as those described above are adopting or are beginning to adopt DL models and techniques to determine information for specimens from the output of the tool hardware (e.g., images). When properly configured and trained, such DL models can provide advantages for determining information about the specimens and processes performed on them. Such advantages can include determining the information faster, with different or less information than previously needed for determining the information, determining more accurate information, being easier to set up with less or different training data, and the like.

While DL models can provide significant benefits for the processes described herein, one obvious obstacle to their acceptance and implementation in the field is their black box nature. For example, how the DL models determine the information they do can be difficult to understand for a user. More specifically, how the DL models achieve their results can be completely opaque to a user due to the nature of the DL models. If how the DL models function is not actually opaque to users, it can still be difficult to understand how they achieve their results. The relatively opaque nature of the DL models compared to other empirical or forward based process simulation models can therefore lead to hesitancy on the part of users to adopt and deploy them despite all of the advantages that they can provide.

One currently used method for conveying how a DL model functions to a user includes checking individual images that are preferred or disliked by the DL model and looking for visual differences on these patch images. However, looking at the individual images that a DL model prefers or dislikes may yield no useful information. For example, a DL model may learn many features, and each image may only present some of them. In addition, there are usually variations within a group of images preferred by a DL model that may not be conveyed or captured by looking at individual images. Furthermore, individual images tend to have a relatively high level of noise, which can obscure any relevant features in the images used by a DL model to generate its results. Therefore, it is obviously hard to draw any conclusions about how a DL model generates its results simply by checking individual images.

Accordingly, it would be advantageous to develop systems and methods for generating information for use in evaluating a DL model that do not have one or more of the disadvantages described above.

### SUMMARY OF THE INVENTION

The following description of various embodiments is not to be construed in any way as limiting the subject matter of the appended claims.

One embodiment relates to a system configured for generating information for use in evaluating a deep learning (DL) model. The system includes a computer subsystem configured for acquiring results generated by a DL model configured for assigning an attribute to images generated for a specimen responsive to a likelihood that the images are images of interest. The computer subsystem is also configured for separating the images into two or more groups based on the attribute such that each of the two or more groups corresponds to different values of the attribute. In addition, the computer subsystem is configured for aligning the images in each of the two or more groups to each other. The computer subsystem is further configured for stacking the aligned images within each of the two or more groups thereby highlighting in the stacked images one or more features of the images to which the attribute is responsive. The computer subsystem is also configured for outputting the stacked images for use in evaluating the DL model. The system may be further configured as described herein.

Another embodiment relates to a computer-implemented method for generating information for use in evaluating a DL model. The method includes the acquiring, separating, aligning, stacking, and outputting steps performed by the computer subsystem as described above. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for generating information for use in evaluating a DL model. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating one embodiment of steps that may be performed for generating information for use in evaluating a deep learning (DL) model;

FIG. 4 is a schematic diagram illustrating an example of differences between individual images generated for a specimen, stacked images for many defects generated for groups of images as described herein, and distribution of defects from a DL model; and

FIG. 5 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for generating information for use in evaluating a deep learning (DL) model. More specifically, the embodiments provide diagnostics tools that use stacked images to show value of DL models in optical wafer inspection and possibly other semiconductor-related yield control processes, like other inspection of wafers and other specimens, defect review, etc.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

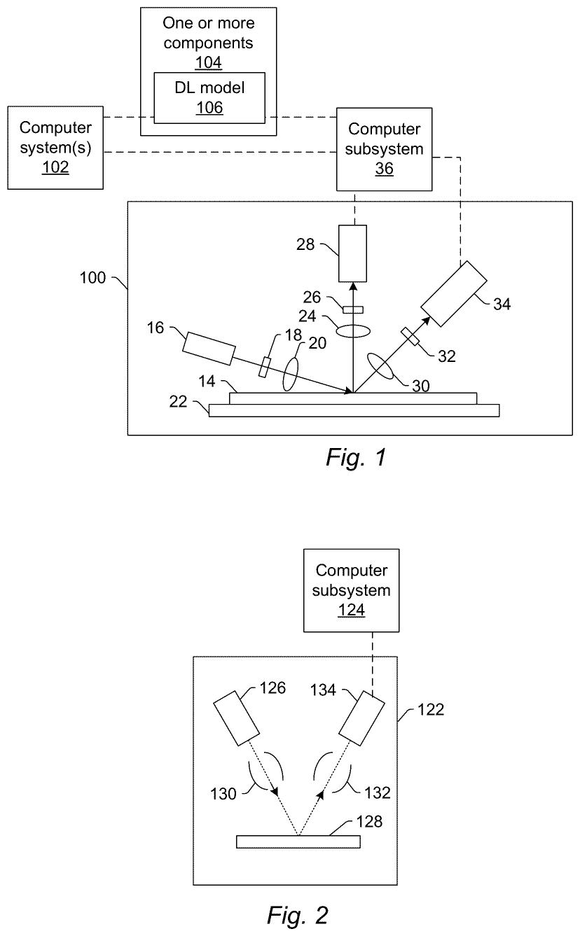

One embodiment of a system configured for generating information for use in evaluating a DL model is shown in FIG. 1. In one embodiment, the system includes inspection subsystem 100 configured for generating images for the specimen. In another embodiment, the images generated for the specimen are optical wafer images generated by an inspection subsystem. In FIG. 1, the inspection subsystem is configured as a light-based inspection subsystem. However, the inspection subsystem may be configured as an electron beam or charged particle beam based inspection subsystem.

In general, the inspection subsystems described herein include at least an energy source and a detector. The energy source is configured to generate energy that is directed to a specimen. The detector is configured to detect energy from the specimen and to generate output responsive to the detected energy.

In a light-based inspection subsystem, the energy directed to the specimen includes light, and the energy detected from the specimen includes light. For example, as shown in FIG. 1, the inspection subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen.

The illumination subsystem may be configured to direct the light to the specimen at different angles of incidence. For example, the inspection subsystem may be configured to alter one or more characteristics of one or more elements of the illumination subsystem such that the light can be directed to the specimen at an angle of incidence that is different than that shown in FIG. 1. In one such example, the inspection subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for inspection.

The inspection subsystem may also include a scanning subsystem configured to change the position on the specimen to which the light is directed and from which the light is detected and possibly to cause the light to be scanned over the specimen. For example, the inspection subsystem may include stage 22 on which specimen 14 is disposed during inspection. The scanning subsystem may include any suitable mechanical and/or robotic assembly (that includes stage 22) that can be configured to move the specimen such that the light can be directed to and detected from different positions on the specimen. In addition, or alternatively, the inspection subsystem may be configured such that one or more optical elements of the inspection subsystem perform some scanning of the light over the specimen such that the light can be directed to and detected from different positions on the specimen. The light may be scanned over the specimen in any suitable fashion such as in a serpentine-like path or in a spiral path.

The inspection subsystem further includes one or more detection channels. At least one of the detection channel(s) includes a detector configured to detect light from the specimen due to illumination of the specimen by the system and to generate output responsive to the detected light. The inspection subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the inspection subsystem that includes two detection channels, the inspection subsystem may include a different number of detection channels (e.g., only one detection channel or two or more detection channels). The detection channel formed by collector 30, element 32, and detector 34 may form one side channel as described above, and the inspection subsystem may include an additional detection channel (not shown) formed as another side channel that is positioned on the opposite side of the plane of incidence. Therefore, the inspection subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the inspection subsystem may also include two or more side channels configured as described above. As such, the inspection subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the inspection subsystem shown in FIG. 1 may be configured for dark field (DF) inspection of specimens. However, the inspection subsystem may also or alternatively include detection channel(s) that are configured for bright field (BF) inspection of specimens. Therefore, the inspection subsystems described herein may be configured for only DF, only BF, or both DF and BF inspection. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors in each of the detection channels may be signals or data, but not image signals or image data. In such instances, a computer subsystem may be configured to generate images of the specimen from the non-imaging output of the detectors. However, in other instances, the detectors may be configured as imaging detectors that are configured to generate imaging signals or image data. Therefore, the inspection subsystem may be configured to generate images in a number of ways.

Computer subsystem 36 may be coupled to the detectors of the inspection subsystem in any suitable manner (e.g., via one or more transmission media, which may include “wired” and/or “wireless” transmission media) such that the computer subsystem can receive the output generated by the detectors. Computer subsystem 36 may be configured to perform a number of functions using the output of the detectors as described further herein. Computer subsystem 36 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

In an electron beam inspection subsystem, the energy directed to the specimen includes electrons, and the energy detected from the specimen includes electrons. In one such embodiment shown in FIG. 2, the inspection subsystem includes electron column 122, and the system includes computer subsystem 124 coupled to the inspection subsystem. Computer subsystem 124 may be configured as described above. In addition, such an inspection subsystem may be coupled to another one or more computer subsystems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam inspection subsystem may be configured to use multiple modes to generate output for the specimen as described further herein (e.g., with different illumination angles, collection angles, etc.). The multiple modes of the electron beam inspection subsystem may be different in any output generation parameters of the inspection subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to perform any step(s) described herein. A system that includes the inspection subsystem shown in FIG. 2 may be further configured as described herein.

FIGS. 1 and 2 are provided herein to generally illustrate configurations of an inspection subsystem that may be included in the system embodiments described herein. Obviously, the inspection subsystem configuration described herein may be altered to optimize the performance of the inspection subsystem as is normally performed when designing a commercial inspection system. In addition, the systems described herein may be implemented using an existing inspection system (e.g., by adding functionality described herein to an existing inspection system) such as the tools that are commercially available from KLA Corp., Milpitas, Calif. For some such systems, the methods described herein may be provided as optional functionality of the inspection system (e.g., in addition to other functionality of the inspection system). Alternatively, the inspection system described herein may be designed “from scratch” to provide a completely new inspection system.

Although the inspection subsystem is described above as being a light or electron beam inspection subsystem, the inspection subsystem may be an ion beam inspection subsystem. Such an inspection subsystem may be configured as shown in FIG. 2 except that the electron beam source may be replaced with any suitable ion beam source known in the art. In addition, the inspection subsystem may include any other suitable ion beam system such as those included in commercially available focused ion beam (FIB) systems, helium ion microscopy (HIM) systems, and secondary ion mass spectroscopy (SIMS) systems.

The inspection subsystem may be configured to generate output, e.g., images, of the specimen with multiple modes. In general, a “mode” is defined by the values of parameters of the inspection subsystem used for generating images of a specimen (or the output used to generate images of the specimen). Therefore, modes may be different in the values for at least one of the parameters of the inspection subsystem (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the inspection subsystem. The inspection subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

In another embodiment, the system includes a metrology subsystem. In a further embodiment, the system includes a defect review subsystem. For example, the embodiments of the inspection subsystem shown in FIGS. 1 and 2 may be modified in one or more parameters to provide different imaging capability depending on the application for which it will be used. In one such example, the inspection subsystem may be configured to have a higher resolution if it is to be used for metrology rather than for inspection. In other words, the embodiments of the inspection subsystem shown in FIGS. 1 and 2 describe some general and various configurations for an imaging subsystem that can be tailored in a number of manners that will be obvious to one skilled in the art to produce systems having different imaging capabilities that are more or less suitable for different applications.

In this manner, the imaging subsystem may be configured for generating output that is suitable for re-detecting defects on the specimen in the case of a defect review system and for measuring one or more characteristics of the specimen in the case of a metrology system. In a defect review system embodiment, computer subsystem 124 shown in FIG. 2 may be configured for re-detecting defects on specimen 128 by applying a defect re-detection method to the output generated by detector 134 and possibly determining additional information for the re-detected defects using the output generated by the detector. In a metrology system embodiment, computer subsystem 36 shown in FIG. 1 may be configured for determining one or more characteristics of specimen 14 using the output generated by detectors 28 and/or 34.

As noted above, the inspection subsystem is configured for scanning energy (e.g., light, electrons, etc.) over a physical version of the specimen thereby generating output for the physical version of the specimen. In this manner, the inspection subsystem may be configured as an “actual” subsystem, rather than a “virtual” subsystem. However, a storage medium (not shown) and computer subsystem(s) 102 shown in FIG. 1 may be configured as a “virtual” system. In particular, the storage medium and the computer subsystem(s) may be configured as a “virtual” inspection system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

The computer subsystem is configured for acquiring results generated by a DL model configured for assigning an attribute to images generated for a specimen responsive to a likelihood that the images are images of interest. The DL model may be applied to all images so that an attribute will be generated for each image representing how likely each image is an image of interest. In one embodiment, the DL model is configured for assigning values of the attribute within a range from 0 to 1, the assigned values of 1 indicate that the images are the images of interest, and the assigned values of 0 indicate that the images are not the images of interest. In other words, the range of the attribute is from 0 to 1, 1 means it is an image of interest, and 0 means it is not an image of interest. However, the values of the attribute assigned to the images by the DL model may include any other suitable attribute types including other numeric values, alphanumeric values, image attribute names (e.g., most likely image of interest, least likely image of interest, DOI image, nuisance image, and the like), and any other suitable attribute values.

In this manner, the attribute value may be a confidence value assigned to each image by the DL model. In particular, the attribute value may be a confidence value that a detected defect is a DOI. If the DL model is relatively confident that a detected defect is a DOI, it would be assigned a higher confidence value. If the DL model is relatively unsure that a detected defect is a DOI, it would be assigned a lower confidence value. The attribute assigned by the DL model is therefore not an attribute or feature of the images themselves but an attribute related to how likely the images are images of interest and images not of interest. In this manner, the attribute that is assigned to the images by the DL model and used by the embodiments described herein may be an attribute that the DL model is currently configured for assigning to the images and is different than any features of the images themselves.

The DL model may therefore be configured for assigning attribute values to individual images that are responsive to whether the images are likely DOI images or likely nuisance images. In this manner, the attribute values assigned by the DL model may be used to separate DOIs from nuisances in inspection results. The DL model may therefore be used for nuisance filtering or defect classification (where classification is simply separating DOIs from nuisances). In some instances, the DL model may be configured for assigning attribute values based on the likelihood that the detected defects are only one particular type of DOI. In this manner, different DL models may be trained to separately assign attribute values responsive to whether the detected defects are likely different types of DOIs, i.e., one DL model trained for one DOI type and another DL model trained for another DOI type. However, it is conceivable that one DL model may be configured for assigning both first attribute values that are responsive to a likelihood that the images are one type of images of interest (for one type of DOI) and second attribute values responsive to a likelihood that the images are another type of images of interest (for a different type of DOI).

The images that are input to the DL model may therefore include only the specimen images generated by the inspection subsystem in which a defect has been detected. Defect detection may be performed on the specimen images generated by the inspection subsystem in any suitable manner known in the art. For example, defect detection may include applying a defect detection method to the specimen images or difference images generated therefrom. In the most simple configuration, defect detection may include applying a threshold to the images (or the difference images) and determining that any image having a signal above the threshold corresponds to a potential defect. The potential defects may include any type of defects that are present on the specimen as well as any nuisances that are erroneously detected as potential defects and therefore have to be separated from the actual defects on the specimen. Defect detection may also be performed by applying any suitable defect detection algorithm to the specimen images such as the MDAT algorithm, which is used by some inspection tools commercially available from KLA.

In some instances, the embodiments described herein may be configured for performing the defect detection. However, another system or method may be configured for performing defect detection on the images, and then only the images in which a defect has been detected may be input to the DL model, either by the other system or method, by a different system or method, or by the embodiments described herein.

However, in other instances, the images that are input into the DL model may include any specimen images generated by the inspection subsystem for the specimen. For example, the DL model may be configured to separate all of the images generated for the specimen into images of interest and images not of interest. In this manner, the images may be input to the DL model without performing any kind of prior defect detection on the images. In this manner, the DL model may be configured for performing a kind of defect detection in all of the images generated for the specimen.

The DL model may have any suitable architecture and configuration. In some instances, the DL model may be the AiryNet™ model that is used by some tools that are commercially available from KLA. Generally speaking, this model is configured as a neural network that extracts unique features from images. For example, the AiryNet™ model can extract information from point spread function (PSF) shape, diffraction ring, and context in the images. Such a neural network may include any suitable layers such as convolution layers, pooling layers, softmax layers, fully connected layers, and the like. Such layers may have any suitable configuration and may be included in the DL model in any suitable number and arrangement. The embodiments described herein may be also configured for use with any other DL model architecture that is configured for separating specimen images and/or images of detected defects into images of interest and images not of interest.

The images to which attribute values are assigned by the DL model may vary depending on the configuration of the DL model and the images used to train it. For example, the images that are input to the DL model may include only difference images generated by a defect detection algorithm. However, the images that are input to the DL model may include only test images generated by the inspection subsystem. The images that are input to the DL model for any one specimen location or detected defect may also include multiple images, which may include two or more of a test image, a reference image, and a difference image. The images may have any suitable size, which may vary depending on the imaging hardware configuration and possibly the DL model architecture. In addition, the images that are input to the DL model for any one specimen location or detected defect may be relatively small patch images, as opposed to much larger frame or job images. The input to the DL model may also include other information for the specimen location or detected defect such as a design clip, which may be a relatively small portion of the design for the specimen corresponding to the specimen location or the location of the detected defect with respect to the design.

In some embodiments, the system includes one or more components executed by the computer subsystem, the one or more components include the DL model, and acquiring the results includes generating the results by inputting the images generated for the specimen into the DL model. Such a system embodiment may or may not also include the inspection subsystem. In this manner, the embodiments described herein may be performed on-tool. For example, as shown in FIG. 1, the system may include one or more components 104 executed by computer subsystem 36 (and/or computer system(s) 102), and the one or more components include DL model 106. Computer subsystem 36 (and/or computer system(s) 102) may input images generated for specimen 14 by inspection subsystem 100 and/or one or more of the computer subsystems into the DL model. DL model 106 may assign attribute values to the specimen images, which may then be sent to computer subsystem 36 (and/or computer system(s) 102). The computer subsystem may then be configured for performing one or more functions described herein with the assigned attributes and the specimen images.

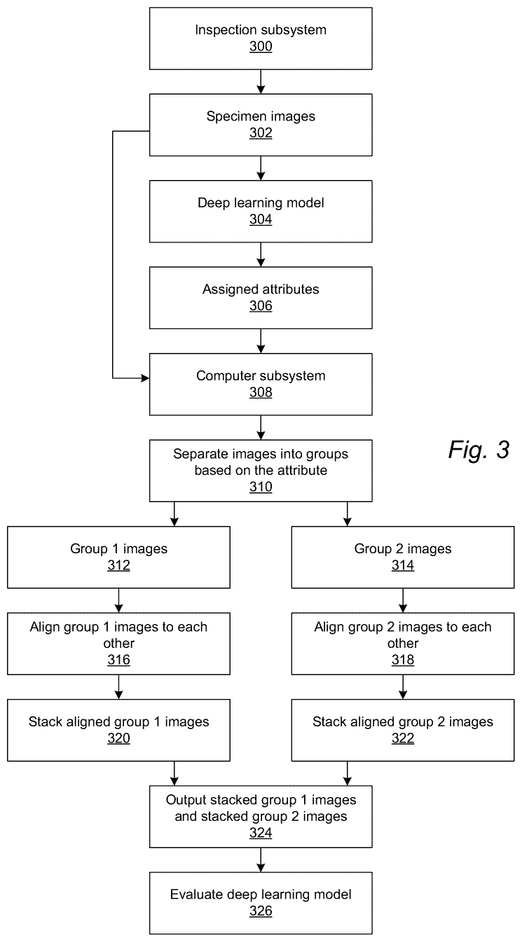

In another example, as shown in FIG. 3, inspection subsystem 300 generates specimen images 302. Specimen images 302, which may include any of the images described herein, are input to DL model 304, which may be configured according to any of the embodiments described herein. DL model 304 assigns attribute values 306 to the specimen images, which are then sent to computer subsystem 308 along with specimen images 302. The computer subsystem may then be configured for performing one or more functions described herein with the assigned attributes and the specimen images.

In a different example, acquiring the results generated by the DL model may not include generating the results with the DL model. Instead, the computer subsystem may acquire the results from a storage medium in which they have been stored or from another method or system that generates the results with the DL model. In this manner, the computer subsystem may acquire the results by retrieving or receiving them from another method or system. Therefore, one system may generate the images described herein, another system may generate the results with the DL model, and the system described herein may be configured for acquiring the results and using them as described further herein. However, one system may be configured for performing all or at least some of these functions.

In one embodiment, the images generated for the specimen are training images in a training data set, and the results are generated by the DL model during training of the DL model. For example, the diagnostics described herein may be performed during DL model training and before it has been released for use. In one such example, the embodiments described herein may perform the one or more functions described herein as part of a validation process performed during DL model training. In addition, as described further herein, the embodiments can help a user to visualize and understand what the DL model is trained to do and so performing the functions described herein prior to release of the DL model for use may be helpful in promoting use of the DL model.

In another embodiment, the DL model is trained prior to generating the results acquired by the computer subsystem. In this manner, the DL model may be trained and then used to generate the results described herein. As such, the results that are acquired and used by the embodiments described herein may be generated after the DL model training has been completed. In other words, the results that are used in the embodiments described herein may be generated by the DL model for non-training images or runtime images. Such results may be generated any time after the DL model has been released for use. For example, the results may be generated right after the DL model has been trained and released for use or at any time after the DL model has been trained, e.g., periodically to check how the DL model is functioning at different points in time.

In one embodiment, the computer subsystem is configured for training the DL model with a training data set that includes images of defects of interest (DOIs) designated as the images of interest. The DL model may be trained using given DOIs. The DL model may also be trained using images of DOIs and nuisances. The training may also be performed in a supervised manner, meaning that the images that are used for training are labeled in some manner, e.g., by a user or by another method or system having known capability for separating detected defects into DOIs and nuisances. Training of the DL model may be performed in any suitable manner known in the art. Generally, training may include inputting the training images into the DL model and modifying one or more parameters of the DL model until the DL model output matches the labels assigned to the training images. Of course, training may be much more complex than this, and the DL model may be trained in any other suitable manner known in the art.

The computer subsystem is also configured for separating the images into two or more groups based on the attribute such that each of the two or more groups corresponds to different values of the attribute. For example, as shown in step 310 of FIG. 3, the computer subsystem may separate the images into groups based on the attribute thereby producing at least two groups of images, e.g., Group 1 images 312 and Group 2 images 314. The embodiments may therefore first group the images by an attribute obtained from the DL model. The images may be grouped based on the value of the attribute, for example, 0.0 to about 0.2, 0.2 to about 0.4, . . . , 0.8 to 1.0. Although two groups of images are shown in FIG. 3 and five ranges of the values of the attribute are described herein, the images may be separated into any suitable number of groups corresponding to any suitable ranges of the values of the attribute.

The computer subsystem is configured for aligning the images in each of the two or more groups to each other. For example, as shown in step 316 of FIG. 3, the computer subsystem may align group 1 images to each other. In addition, as shown in step 318 of FIG. 3, the computer subsystem may align group 2 images to each other. The computer subsystem therefore separately performs image alignment for each of the groups of images.

In one embodiment, aligning the images includes aligning the images based on a location of a defect detected in the images. In other words, the images may be aligned by the location of the detected defect. Such image alignment may be performed in any suitable manner known in the art. In addition, although alignment may be performed in other ways, aligning the images based on the detected defect locations (rather than say some other pattern that might be present in the images) is advantageous for the embodiments described herein because it increases the likelihood that the features of the detected defects that are most common in the images will be highlighted in the stacked images and that the features of the detected defects that are least common in the images will be deemphasized in the stacked images.

Image alignment is therefore preferably performed before the stacking described further herein. As described further herein, stacking images within a group corresponding to a range of attribute values helps to reduce the noise in the individual images and makes the features of the individual images that the DL model uses to assign the attribute values more obvious. Stacking alone may reduce the noise in the stacked images compared to the individual images. However, stacking without prior image alignment may artificially alter the features of the detected defects that were used to assign the attribute values to a degree that can reduce the emphasis of the relied-on features in the stacked images. For example, without image alignment, the PSF of the detected defects may be artificially larger in the stacked images than if the images are aligned to each other prior to stacking. Therefore, image alignment performed prior to image stacking can help ensure that the detected defect features that are emphasized in the stacked images accurately reflect the feature(s) that were utilized by the DL model for attribute value assignment.

The computer subsystem is further configured for stacking the aligned images within each of the two or more groups thereby highlighting in the stacked images one or more features of the images to which the attribute is responsive. In this manner, the images are stacked together in each group. For example, as shown in step 320 of FIG. 3, the computer subsystem stacks the aligned group 1 images. The computer subsystem also stacks the aligned group 2 images in step 322. Stacking the images within each group highlights the feature(s) that influence the value of the attribute. By checking the stacked images from a low attribute value group to a high attribute value group, the feature(s) that the DL model uses should become clear or will at least be clearer than in the individual images that were input to the DL model. In this manner, one important new feature of the embodiments described herein is that they use stacked images to keep and highlight common features within a group of defects separated by model preference.

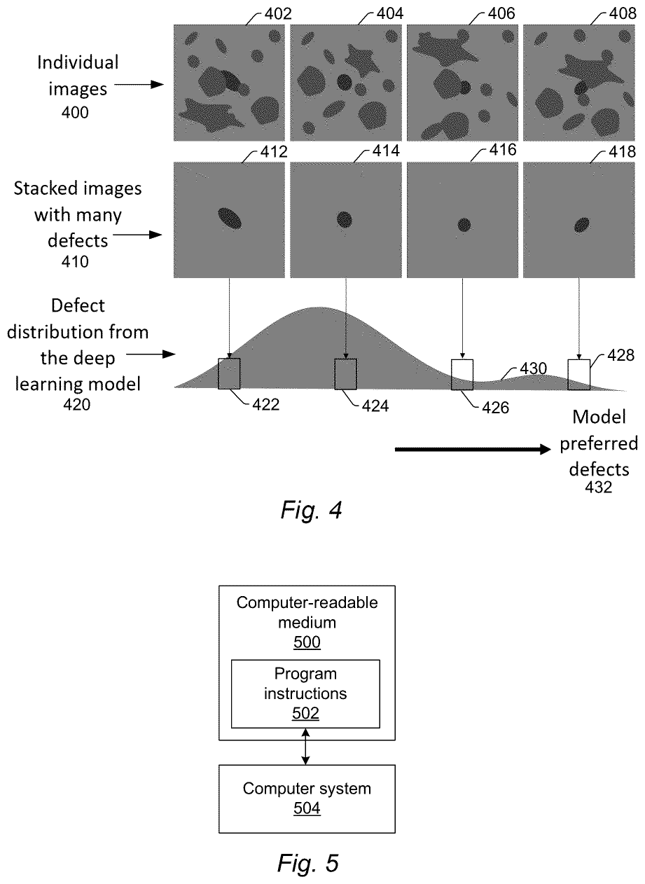

As shown in FIG. 4, stacking individual images separated into different groups makes clear that a DL model uses the rotation of the detected defect shape to determine whether it is a DOI. More specifically, FIG. 4 shows individual images 400, each separated into a different group as described further herein. For example, individual image 402 may be separated into a first group corresponding to the lowest range of attribute values, individual image 404 may be separated into a second group corresponding to the next to lowest range of attribute values, individual image 406 may be separated into a third group corresponding to next to highest range of attribute values, and individual image 408 may be separated into a fourth group corresponding to the highest range of attribute values. As can be seen in these cartoon image examples of detected defects and would be even more clear in actual images of detected defects, the features of the detected defects in the individual images are relatively difficult to discern visually.

Even when multiple individual images assigned attribute values in the same range are displayed to a user, the features of the defects that are similar from image-to-image (and therefore likely played a part in the detected defects being assigned attribute values in the same range) may still be difficult to comprehend visually. For example, even if the computer subsystem displayed dozens of images of DOIs and dozens of images of nuisances based on attribute values assigned by the DL model, similarities in features from DOI-to-DOI and nuisance-to-nuisance may be difficult to ascertain. In addition, differences in features of DOIs versus nuisances identified as such by the DL model may be difficult to ascertain visually even when dozens of images of DOIs and nuisances are displayed. The detected defect signal in each image can also be obscured by noise in the images thereby further obscuring the features of the detected defects that caused them to be assigned their attribute values by the DL model.

FIG. 4 also shows stacked images with many detected defects 410 generated for each of the groups. For example, stacked images 412, 414, 416, and 418 are generated for the groups in which individual images 402, 404, 406, and 408, respectively, are included. As shown by comparison of the individual images and their corresponding stacked images in FIG. 4, features of the individual images to which the attribute is responsive are highlighted in the stacked images, meaning that the features of the images (which may include at least the features of the detected defects in the images, but possibly also or alternatively other features of the images) are much clearer in the stacked images compared to the individual images. In particular, as shown by comparing the rotation (or orientation of the long axis) of the detected defects in the stacked images, the DL model has assigned a low attribute value to detected defects that point up to the left and a high attribute value to detected defects that point up to the right. The DL model also has assigned mid-range attribute values to detected defects that are relatively round in shape. These differences in the image features highlighted in the stacked images are not as readily apparent in their corresponding individual images.

FIG. 4 also shows an example detected defect distribution as a function of attribute value from the DL model 420. Different portions of detected defect distribution 430 therefore correspond to different groups. For example, stacked images 412, 414, 416, and 418 are generated from individual images of detected defects in portions 422, 424, 426, and 428, respectively, of the distribution. As can be seen from this detected defect distribution, the numbers of detected defects separated into the lowest attribute value groups are substantially higher than the numbers of detected defects separated into the highest attribute value groups.

Such a detected defect distribution is consistent with the inspection results generated by many currently used inspection processes. In particular, currently used inspection processes typically detect a substantial amount of nuisances or nuisance defects, which can be generally defined in the art as detected events that are not actually defects but are detected as potential defects due to noise and other marginalities that can exist between the specimen and the inspection tool. For example, to ensure that DOIs are detected in an inspection process, a threshold must often be set which also results in the detection of a substantial number of nuisances. Therefore, after defect detection, the nuisances have to be separated from the DOIs in some manner so that results for only the DOIs can be isolated and used separately from the nuisance results for functions described further herein. As shown by the detected defect distribution in FIG. 4 then, the DL model preferred defects 432, i.e., the detected defects assigned the highest attribute values, are relatively low in number, which is consistent with the expected DL model results, e.g., relatively few detected defects assigned the highest attribute values since the number of detected DOI will typically be much lower than the number of detected nuisance.

In one embodiment, stacking the aligned images deemphasizes one or more other features of the images to which the attribute is less responsive than the one or more features. For example, individual images can show local feature variations. In addition, the local features may vary from individual image-to-individual image within a group (not shown). However, by stacking the images in a group defined based on DL model preference as described herein, the local feature variations between individual images in the same group can be reduced thereby revealing the common features of the individual images used by the DL model to assign the attribute values.

In another embodiment, stacking the aligned images deemphasizes noise in the images. For example, individual images 400 show relatively high noise compared to stacked images 402. In this manner, by stacking the images in a group defined based on model preference, the noise can be reduced thereby also revealing the common features of the individual images used by the model to assign the attribute values. This capability is one of the important new features of the embodiments described herein. In particular, it is new to use stacked images to suppress noise in the context of finding out what a DL model has learned.

In some embodiments, the computer subsystem is configured for transforming the aligned images into a different domain, and stacking the aligned images includes stacking the transformed aligned images within each of the two or more groups. For example, instead of stacking the images, the individual images can be transformed into different domains (frequency, wavelet, etc.) before getting stacked together. Transforming the images into a different domain may be performed in any suitable manner known in the art. The transformed images may otherwise be used in the same manner described herein. In addition, the image transformation may be performed before or after image alignment.

The computer subsystem is configured for outputting the stacked images for use in evaluating the DL model. For example, as shown in step 324 of FIG. 3, the computer subsystem outputs the stacked group 1 images and the stacked group 2 images, which may be input to evaluate DL model step 326, which may be performed as described further herein. The evaluation of (or diagnostics performed for) the DL model may therefore be performed using the stacked images instead of individual images. As described above, the stacked images visually contain information for the features that the DL model uses to assign attribute values that indicate how likely an individual image is an image of interest. One important new feature of the embodiments described herein is therefore that they can be used to visualize what a DL model learns from optical wafer inspection data.

In one embodiment, outputting the stacked images includes displaying the stacked images to a user thereby conveying to the user the one or more features of the images used by the DL model for assigning the attribute. For example, the embodiments described herein enable users to visualize the results from a DL model in optical images. In other words, the stacked images generated by the embodiments described herein can help a user to visualize common features in the images that the DL model extracted and relied upon to generate its results. A user of a DL model generally prefers to make sense of the model. The embodiments described herein allow users to understand what features that the DL model learns from the training data.

In another embodiment, outputting the stacked images includes displaying the stacked images for each of the two or more groups to a user thereby conveying to the user the one or more features of the images to which the attribute is responsive. For example, the embodiments described herein stack images that the model prefers (high attribute value images) and stack images of what the model dislikes (low attribute value images). By displaying to a user both the stacked images that the model prefers and the stacked images that the model dislikes, the stacked images can be compared and the features of the stacked images that are different can be identified. In particular, the differences between the stacked images will be the features that the model uses to separate images. The embodiments described herein are therefore intuitive and effective. With the embodiments described herein, the user will have confidence in the DL model before applying it in production. Stacking the images as described herein also enables visualization of how sensitive the DL model is to features in the images of the detected defects.

In some embodiments, the one or more features highlighted in the stacked images to which the attribute is responsive are visually perceptible by a user in fewer than all of the images in any one of the two or more groups. For example, differences in the shape of the detected defects assigned to different groups based on their different attribute values may not be visually perceptible in individual images 400 shown in FIG. 4. The stack of the images helps to visualize the result because noise and not useful features in the images are stacked out.

As described above, the embodiments provide important new information to users about the performance of a DL model. For example, DL models are going to be widely used on semiconductor yield-related tools. However, users do not like black-box type of features. DL models are often like black boxes. The embodiments described herein allow users to understand what the black box is doing to some extent, which helps to promote the use of DL features.

In one embodiment, evaluating the DL model includes comparing the highlighted one or more features in the stacked images for each of the two or more groups and identifying the one or more features used by the DL model to assign the attribute to the images based on the comparing. For example, the computer subsystem may be configured to compare the stacked image results to thereby identify one or more features of the stacked images that are different from each other. In one such example shown in FIG. 4, comparison of stacked images 412 and 418 shows that the orientation of the detected defects in the lowest attribute value group is different than the orientation of the detected defects in the highest attribute value group. Therefore, by comparing stacked images 412 and 418, the computer subsystem may identify the different orientations of the detected defects as the one or more features used by the DL model to assign the attribute to the images. Therefore, evaluating the DL model may be performed by the computer subsystem described herein (in an automated or semi-automated way) or by a user in a manual manner.

In another embodiment, evaluating the DL model includes determining if the DL model is overfitting to non-meaningful features in the stacked images in any one of the two or more groups. For example, a DL model can overfit to non-meaningful features, and the embodiments described herein give the user a way to check if the model is overfitting before applying the model in the field. The computer subsystem may also be configured to determine if the DL model is overfitting to the non-meaningful features in the stacked images.

In a further embodiment, evaluating the DL model includes determining if the DL model is suitable for use in assigning the attribute to images generated for other specimens. For example, the DL model may be evaluated as described above, and based on the evaluations, the computer subsystem or a user may determine if the DL model is suitable for release to be used for other specimens. In one such example, if the stacked images for different groups show that the DL model is capable of separating images of interest from images not of interest, then the DL model may be released for use. In another such example, if the features of the stacked images show that the DL model is not overfitting to non-meaningful features in the images, then the DL model may be released for use.

If the DL model is determined to be unsuitable for use in assigning the attribute to other specimen images, then the computer subsystem or a user may determine if additional training should be performed for the DL model. In addition or alternatively, when a DL model is determined to be unsuitable for use in assigning the attribute to other specimen images, the computer subsystem or a user may make one or more changes to the DL model. Such changes may include, for example, a change to the DL model architecture or replacing the DL model with a different DL model. The steps described herein may then be performed for the altered DL model or the other DL model to evaluate if it is suitable for use in the application for which it is intended.

The computer subsystem may generate results, which may include the results of any of the steps described herein. The results may include the trained and evaluated DL model, the stacked images, or any other information generated by the embodiments described herein. The results may be generated by the computer subsystem in any suitable manner. The results may have any suitable form or format such as a standard file type. The computer subsystem may generate the results and store the results such that the results can be used by the computer subsystem and/or another system or method to perform one or more functions for or with the DL model. For example, the stacked images may be stored and/or displayed as described herein such that a user or another system or method can evaluate the DL model as described herein. In another example, the trained and evaluated DL model determined to be suitable for use may be stored in a recipe such as an inspection recipe so that it can be used for assigning the attribute to specimen images generated for other specimens. In an additional example, a file name and location for the trained and evaluated DL model determined to be suitable for use may be stored in an inspection recipe so that it can be used for assigning the attribute to specimen images generated for other specimens.

The computer subsystem may be configured for storing the results in any suitable computer-readable storage medium. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc.

A DL model evaluated as described herein may also be stored as described above and used to perform inspection on one or more other specimens. Results and information generated by performing inspection on a specimen that uses a DL model as described herein or by inputting specimen images into a DL model configured as described herein may include, therefore, images of interest (likely DOI images) and images not of interest (likely nuisance images), which may be used in a variety of manners by the embodiments described herein and/or other systems and methods. Such functions include, but are not limited to, altering a process such as a fabrication process or step that was or will be performed on the inspected specimen or another specimen in a feedback or feedforward manner. For example, the computer subsystem may be configured to determine one or more changes to a process that was or will be performed on a specimen inspected as described herein based on the likely DOIs. The changes to the process may include any suitable changes to one or more parameters of the process. The computer subsystem preferably determines those changes such that the DOIs can be reduced or prevented on other specimens on which the revised process is performed, the DOIs can be corrected or eliminated on the specimen in another process performed on the specimen, the DOIs can be compensated for in another process performed on the specimen, etc. The computer subsystem may determine such changes in any suitable manner known in the art.

Those changes can then be sent to a semiconductor fabrication system (not shown) or a storage medium (not shown) accessible to the computer subsystem and the semiconductor fabrication system. The semiconductor fabrication system may or may not be part of the system embodiments described herein. For example, the computer subsystem and/or inspection subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of the system described above may be combined together into one single embodiment. In other words, unless otherwise noted herein, none of the system embodiments are mutually exclusive of any other system embodiments.

Another embodiment relates to a computer-implemented method for generating information for use in evaluating a DL model. The method includes acquiring results generated by a DL model configured for assigning an attribute to images generated for a specimen responsive to a likelihood that the images are images of interest. The method also includes separating the images into two or more groups based on the attribute such that each of the two or more groups corresponds to different values of the attribute. In addition, the method includes aligning the images in each of the two or more groups to each other. The method further includes stacking the aligned images within each of the two or more groups thereby highlighting in the stacked images one or more features of the images to which the attribute is responsive. The method also includes outputting the stacked images for use in evaluating the DL model.

Each of the steps of the method may be performed as described further herein. The method may also include any other step(s) that can be performed by the inspection subsystem, computer subsystem, and DL model described herein. In addition, the method described above may be performed by any of the system embodiments described herein.

An additional embodiment relates to a non-transitory computer-readable medium storing program instructions executable on a computer system for performing a computer-implemented method for generating information for use in evaluating a DL model. One such embodiment is shown in FIG. 5. In particular, as shown in FIG. 5, non-transitory computer-readable medium 500 includes program instructions 502 executable on computer system 504. The computer-implemented method may include any step(s) of any method(s) described herein.

Program instructions 502 implementing methods such as those described herein may be stored on computer-readable medium 500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 504 may be configured according to any of the embodiments described herein.

Further modifications and alternative embodiments of various aspects of the invention will be apparent to those skilled in the art in view of this description. For example, methods and systems for generating information for use in evaluating a DL model are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for generating information for use in evaluating a deep learning model, comprising:
a computer subsystem configured for:
acquiring results generated by a deep learning model configured for assigning an attribute to images generated for a specimen responsive to a likelihood that the images are images of interest;
separating the images into two or more groups based on the attribute such that each of the two or more groups corresponds to different values of the attribute;
aligning the images in each of the two or more groups to each other;
stacking the aligned images within each of the two or more groups thereby highlighting in the stacked images one or more features of the images to which the attribute is responsive; and
outputting the stacked images for use in evaluating the deep learning model.

2. The system of claim 1, wherein stacking the aligned images deemphasizes one or more other features of the images to which the attribute is less responsive than the one or more features.

3. The system of claim 1, wherein stacking the aligned images deemphasizes noise in the images.

4. The system of claim 1, wherein said outputting comprises displaying the stacked images to a user thereby conveying to the user the one or more features of the images used by the deep learning model for assigning the attribute.

5. The system of claim 1, wherein said outputting comprises displaying the stacked images for each of the two or more groups to a user thereby conveying to the user the one or more features of the images to which the attribute is responsive.

6. The system of claim 1, wherein the one or more features highlighted in the stacked images to which the attribute is responsive are visually perceptible by a user in fewer than all of the images in any one of the two or more groups.

7. The system of claim 1, wherein the deep learning model is further configured for assigning values of the attribute within a range from 0 to 1, wherein the assigned values of 1 indicate that the images are the images of interest, and wherein the assigned values of 0 indicate that the images are not the images of interest.

8. The system of claim 1, wherein said aligning comprises aligning the images based on a location of a defect detected in the images.

9. The system of claim 1, wherein evaluating the deep learning model comprises comparing the highlighted one or more features in the stacked images for each of the two or more groups and identifying the one or more features used by the deep learning model to assign the attribute to the images based on said comparing.

10. The system of claim 1, wherein evaluating the deep learning model comprises determining if the deep learning model is overfitting to non-meaningful features in the stacked images in any one of the two or more groups.

11. The system of claim 1, wherein evaluating the deep learning model comprises determining if the deep learning model is suitable for use in assigning the attribute to images generated for other specimens.

12. The system of claim 1, wherein the computer subsystem is further configured for training the deep learning model with a training data set comprising images of defects of interest designated as the images of interest.

13. The system of claim 1, wherein the images generated for the specimen are training images in a training data set, and wherein the results are generated by the deep learning model during training of the deep learning model.

14. The system of claim 1, wherein the deep learning model is trained prior to generating the results acquired by the computer subsystem.

15. The system of claim 1, wherein the computer subsystem is further configured for transforming the aligned images into a different domain, and wherein stacking the aligned images comprises stacking the transformed aligned images within each of the two or more groups.

16. The system of claim 1, further comprising one or more components executed by the computer subsystem, wherein the one or more components comprise the deep learning model, and wherein said acquiring comprises generating the results by inputting the images generated for the specimen into the deep learning model.

17. The system of claim 1, further comprising an inspection subsystem configured for generating the images for the specimen.

18. The system of claim 1, wherein the images generated for the specimen are optical wafer images generated by an inspection subsystem.

19. A non-transitory computer-readable medium, storing program instructions executable on a computer system for performing a computer-implemented method for generating information for use in evaluating a deep learning model, wherein the computer-implemented method comprises:
acquiring results generated by a deep learning model configured for assigning an attribute to images generated for a specimen responsive to a likelihood that the images are images of interest;
separating the images into two or more groups based on the attribute such that each of the two or more groups corresponds to different values of the attribute;
aligning the images in each of the two or more groups to each other;
stacking the aligned images within each of the two or more groups thereby highlighting in the stacked images one or more features of the images to which the attribute is responsive; and
outputting the stacked images for use in evaluating the deep learning model.

20. A computer-implemented method for generating information for use in evaluating a deep learning model, comprising:
acquiring results generated by a deep learning model configured for assigning an attribute to images generated for a specimen responsive to a likelihood that the images are images of interest;
separating the images into two or more groups based on the attribute such that each of the two or more groups corresponds to different values of the attribute;
aligning the images in each of the two or more groups to each other;
stacking the aligned images within each of the two or more groups thereby highlighting in the stacked images one or more features of the images to which the attribute is responsive; and
outputting the stacked images for use in evaluating the deep learning model, wherein said acquiring, separating, aligning, stacking, and outputting are performed by a computer subsystem.
